(19) United States
(12) Patent Application Publication
(10) Pub. No.: US 2026/0032514 A1
(43) Pub. Date: Jan. 29, 2026

(54) Sending a Data Unit to a Radio Access Network Node, and Transmitting a Data Unit to a User Equipment

(71) Applicant: Telefonaktiebolaget LM Ericsson (publ), Stockholm (SE)

(72) Inventors: Yazid Lyazidi, Hässelby (SE); Nianshan Shi, Järfälla (SE); Jose Luis Pradas, Stockholm (SE)

(21) Appl. No.: 18/995,243

(22) PCT Filed: Jun. 19, 2023
(86) PCT No.: PCT/SE2023/050625

§ 371 Date: Jan. 16, 2025

Related U.S. Application Data
(60) Provisional application No. 63/391,457, filed on Jul. 22, 2022.

(51) Int. Cl. H04W 28/08

(52) U.S. Cl. CPC H04W 28/0975

(57) ABSTRACT

Methods and apparatus are disclosed. In an example, a method performed by a first Radio Access Network (RAN) node for sending a data unit to a second RAN node is disclosed. The method comprises receiving a first data unit for transmission to a User Equipment (UE), determining that a packet delay budget (PDB) for the first data unit and/or a set of data units including the first data unit will not be satisfied by transmission of the first data unit and/or the set of data units by the first RAN node, and sending the first data unit to a second RAN node for transmission to the UE.

### TECHNICAL FIELD

Examples of this disclosure relate to sending a data unit to a Radio Access Network (RAN) node, and transmitting a data unit to a User Equipment (UE).

### BACKGROUND

extended Reality (XR) and Cloud Gaming are some of the media applications under consideration within a 5G system. XR is an umbrella term for different types of realities and refers to all real and virtual combined environments and human-machine interactions generated by computer technology and wearables. It includes representative forms such as Augmented Reality (AR), Mixed Reality (MR) and Virtual Reality (VR) and the areas interpolated among them.

One specific aspect to be considered is the role of Edge Computing as a network architecture to enable XR and Cloud Gaming. Edge Computing is a concept that enables cloud computing capabilities and service environments to be deployed close to the cellular network. It promises several benefits such as lower latency, higher bandwidth, reduced backhaul traffic and prospects for several new services on application architecture for enabling Edge Applications (3GPP TR 23.758). Edge Applications are expected to take advantage of the low latencies enabled by 5G and the Edge network architecture to reduce end-to-end application-level latencies. Edge Computing is a valuable enabler which should be considered to help 5G systems achieve the required performance to enable XR and Cloud Gaming.

5G New Radio (NR) is designed to support applications demanding high throughput and low latency in line with the requirements posed by the support of XR and Edge Computing applications in NR networks. XR and Edge Computing are services enabled by Rel-15 NR networks.

Many XR applications will generate traffic periodically with a variable size. When the application packet enters the internet, the initial packet may be transmitted into a single PDU in the network or may be segmented several PDUs. One application packet could, for instance, correspond to one or several IP packets.

IP packets will arrive at the Radio Access Node (RAN) Packet Data Convergence Protocol (PDCP) layer, i.e. PDCP service data units (SDUs), and the PDCP layer will create PDCP protocol data units (PDUs) and will deliver then to lower layers. When an IP packet arrives at the PDCP layer, the PDCP layer starts a PDCP discard timer. When this timer expires, the PDCP layer discards the PDCP SDU as well as the corresponding PDCP PDU. If the PDCP PDU was delivered to lower layers, PDCP indicates the discard to lower layers. Lower layers e.g. Radio Link Control (RLC) layer will discard the PDCP PDUs. For example, for the case of RLC layer, the PDCP PDU may be a RLC SDU and will be discarded if the RLC SDU or any segment of the RLC SDU has not yet been transmitted to lower layers.

There currently exist certain challenge(s). For example, XR Application PDUs may have time constraints, such as a packet delay budget (PDB). This means that one or a set of data units such as PDUs (or each data unit of a set) may need to reach the receiver within a certain period of time, i.e. with a limited latency. If the application PDU(s) is/are not received by this time, the application PDU(s) is/are not of any use, and may be discarded.

### SUMMARY

Certain aspects of the disclosure and their embodiments may provide solutions to these or other challenges. For example, example aspects of this disclosure provide methods for offloading the data units (hereinafter referred to in some examples as PDCP SDUs or PDUs, though any example can be extended to other data units) of a QoS flow (e.g. XR or other type of QoS flow) handling from one first RAN node to a second RAN node, when the first RAN node foresees that it cannot handle all XR PDCP SDUs of the XR QoS flow according to their PDB. In some examples, associated data units (e.g. for I and P frames) may be allocated in two different QoS flows, and thus the two (or more) QoS flows are associated. Thus, during QoS flow offloading, the two (or more) QoS flows should be handled by the same RAN node (e.g. a second RAN node) that receives the offloaded traffic to avoid complication. Thus, this may for example be indicated to a first and/or second RAN node and the RAN nodes (or at least the first RAN node) involved are aware of the association. In examples where I and P Frames are in the same QoS flow, the I/P Frames will be carried in the same data tunnel, and no QoS association is needed.

One aspect of this disclosure provides a method performed by a first Radio Access Network (RAN) node for sending a data unit to a second RAN node. The method comprises receiving a first data unit for transmission to a User Equipment (UE), and determining that a packet delay budget (PDB) for the first data unit and/or a set of data units including the first data unit will not be satisfied by transmission of the first data unit and/or the set of data units by the first RAN node. The method also comprises sending the first data unit to a second RAN node for transmission to the UE.

Another aspect of this disclosure comprises a method performed by a second Radio Access Network (RAN) node for transmitting a data unit to a user equipment (UE). The method comprises receiving, from a first RAN node, a request to send, to the second RAN node for transmission to the UE, a first data unit and/or one or more of a set of data units including the first data unit, selecting a process for the first RAN node to send at least the first data unit to the second RAN node for transmission to the UE, and sending, to the first RAN node, a response to the request, wherein the request includes information identifying the selected process. The method also comprises receiving, from the first RAN node, at least the first data unit according to the selected process, and transmitting at least the first data unit to the UE.

A further aspect of this disclosure provides a first Radio Access Network (RAN) node for sending a data unit to a second RAN node. The first RAN node comprises a processor and a memory. The memory contains instructions executable by the processor such that the first RAN node is operable to receive a first data unit for transmission to a User Equipment (UE), determine that a packet delay budget (PDB) for the first data unit and/or a set of data units including the first data unit will not be satisfied by transmission of the first data unit and/or the set of data units by the first RAN node, and send the first data unit to a second RAN node for transmission to the UE.

A still further aspect of the present disclosure provides a second Radio Access Network (RAN) node for transmitting a data unit to a User Equipment (UE). The second RAN node comprises a processor and a memory. The memory contains instructions executable by the processor such that the second RAN node is operable to receiving, from a first RAN node, a request to send, to the second RAN node for transmission to the UE, a first data unit and/or one or more of a set of data units including the first data unit, select a process for the first RAN node to send at least the first data unit to the second RAN node for transmission to the UE, send, to the first RAN node, a response to the request, wherein the request includes information identifying the selected process, receive, from the first RAN node, at least the first data unit according to the selected process, and transmit at least the first data unit to the JE.

An additional aspect of the present disclosure provides a first Radio Access Network (RAN) node for sending a data unit to a second RAN node. The first RAN node is configured to receive a first data unit for transmission to a User Equipment (UE), determine that a packet delay budget (PDB) for the first data unit and/or a set of data units including the first data unit will not be satisfied by transmission of the first data unit and/or the set of data units by the first RAN node, and send the first data unit to a second RAN node for transmission to the UE.

Another aspect of the present disclosure provides a second Radio Access Network (RAN) node for transmitting a data unit to a User Equipment (UE). The second RAN node is configured to receive, from a first RAN node, a request to send, to the second RAN node for transmission to the UE, a first data unit and/or one or more of a set of data units including the first data unit, select a process for the first RAN node to send at least the first data unit to the second RAN node for transmission to the UE, send, to the first RAN node, a response to the request, wherein the request includes information identifying the selected process, receive, from the first RAN node, at least the first data unit according to the selected process, and transmit at least the first data unit to the UE.

Certain embodiments may provide one or more of the following technical advantage(s). For example, example embodiments may allow for offloading of XR traffic to another RAN node, e.g. when MR-DC is deployed, which can be an alternative to dropping or discarding of XR packets, especially if dropping packets can decrease the overall Quality of Experience (QoE) of the XR application (e.g. occasional black screens or stutters).

### BRIEF DESCRIPTION OF THE FIGURES

For a better understanding of the embodiments of the present disclosure, and to show how it may be put into effect, reference will now be made, by way of example only, to the accompanying drawings, in which:

FIG. 1 depicts a method in accordance with particular embodiments;

FIG. 2 depicts another method in accordance with particular embodiments;

FIG. 3 shows an example of an overall signaling flow for the “XR offloading” from one RAN node to another;

FIG. 4 shows an example of a first RAN node sending an offloading message to a second RAN node;

FIG. 5 shows another example of a first RAN node sending an offloading message to a second RAN node;

FIG. 6 shows examples of XR offloading proposals at a first RAN node and examples of XR offloading responses at a second RAN node;

FIG. 7 shows an example of a communication system in accordance with some embodiments;

FIG. 8 shows a UE in accordance with some embodiments;

FIG. 9 shows a network node in accordance with some embodiments;

FIG. 10 is a block diagram of a host in accordance with various aspects described herein;

FIG. 11 is a block diagram illustrating a virtualization environment in which functions implemented by some embodiments may be virtualized; and

FIG. 12 shows a communication diagram of a host communicating via a network node with a UE over a partially wireless connection in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art.

As indicated above, example aspects of this disclosure provide methods for offloading the data units (hereinafter referred to in some examples as PDCP SDUs or PDUs, though any example can be extended to other data units) of a QoS flow (e.g. XR or other type of QoS flow) handling from one first RAN node to a second RAN node, when the first RAN node foresees that it cannot handle all XR PDCP SDUs of the XR QoS flow according to their PDB. In some examples, associated data units (e.g. for I and P frames) may be allocated in two different QoS flows, and thus the two (or more) QoS flows are associated. Thus, during QoS flow offloading, the two (or more) QoS flows should be handled by the same RAN node (e.g. a second RAN node) that receives the offloaded traffic to avoid complication. Thus, this may for example be indicated to a first and/or second RAN node and the RAN nodes (or at least the first RAN node) involved are aware of the association. In examples where I and P Frames are in the same QoS flow, the I/P Frames will be carried in the same data tunnel, and no QoS association is needed.

In either case, and more generally, when the serving RAN node has weakened radio conditions, it should seek for other radio resources to ensure the fulfillment of e.g. the XR service requirements, or otherwise a packet delay budget (PDB). Example embodiments of this disclosure may allow a first RAN node to request the second RAN node to perform an “offloading”: this may for example comprise performing a QoS offloading, and/or split bearer, and/or duplication. In some examples, the second NG-RAN node determines (e.g. according to the QoS requirement and its resource condition) which method to take.

Some examples of this disclosure may therefore achieve a high bit rate, high reliability and/or low latency for transmissions of data units to a UE.

In an example, a first serving RAN node (e.g. master node, MN) receives a first XR PDCP data unit of a PDU Set. Based on the PDB of the XR QoS flow, it foresees that it cannot handle all packets in the PDU Set for this QoS flow. This can happen for example when the serving NG-RAN node has other traffic to cater to and/or the radio conditions weaken. In this case, the serving NG-RAN node should seek for other radio resources to ensure the fulfillment of the XR services by performing an offloading procedure to a second RAN node, e.g. secondary node (SN).

Example embodiments may include one or more of the following features:
the first RAN node (e.g. MN) may request a second RAN node (e.g. SN) to perform QoS offloading (with indication of QoS flow association, if applicable), and/or split bearer, and/or PDCP Duplication.
It may then be determined by the second RAN node to determine, e.g. based on its own resource situation and the QoS or PDB requirement, a process for the first node sending data unit(s) to the second node, e.g. to either perform QoS offloading (e.g. to setup the required QoS flow and map it to a Data Radio Bearer, DRB), or perform Split bearer, or perform PDCP duplication, or QoS offload with split bearer.
The second RAN node may respond to the first NG-RAN node with the decision, and the user plane data tunnel is set up accordingly.

The first RAN node may inform the UE and reconfigure the Radio bearer accordingly.

Certain examples of this disclosure are described in terms of particular QoS flows (e.g. XR flows), radio access technologies (e.g. NR and NG-RAN nodes) and data units (e.g. PDCP SDUs or PDUs). However, any of these examples can be extended to any suitable RAT or data units, and the data units may or may not be associated with any particular service or flow such as a QoS flow, or may be associated with a different type of QoS flow.

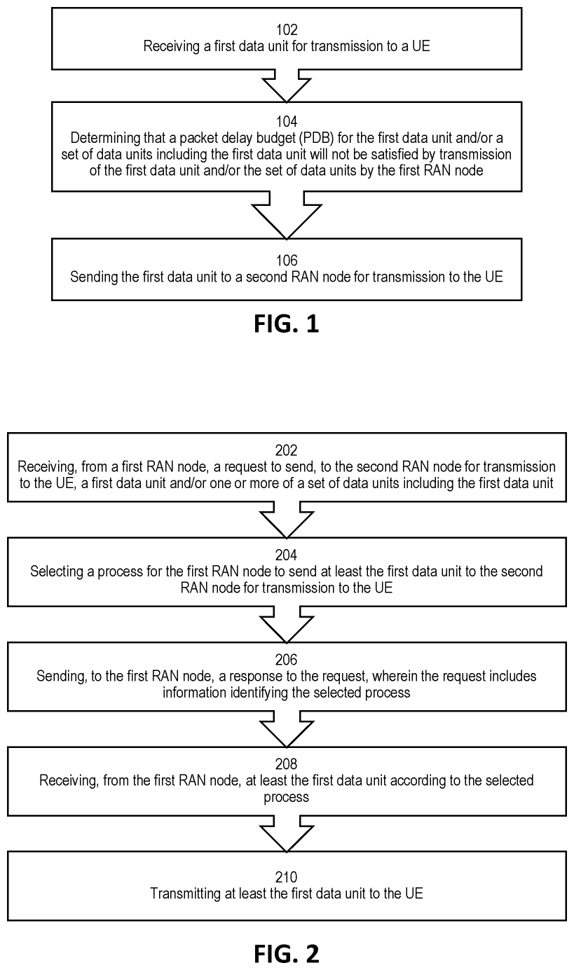

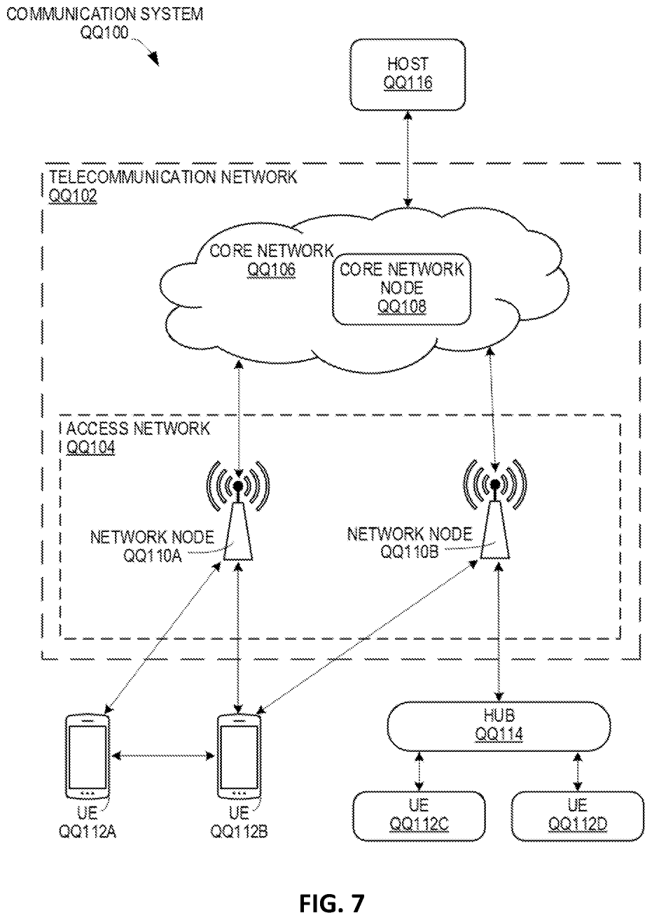

FIG. 1 depicts a method in accordance with particular embodiments, e.g. a method performed by a first Radio Access Network (RAN) node for sending a data unit to a second RAN node. The method 1 may be performed by a network node (e.g. the network node QQ110 or network node QQ300 as described later with reference to FIGS. 7 and 9 respectively). The method begins at step 102 with receiving a first data unit for transmission to a User Equipment (UE), and then with step 104 with determining that a packet delay budget (PDB) for the first data unit and/or a set of data units including the first data unit will not be satisfied by transmission of the first data unit and/or the set of data units by the first RAN node. Next, step 106 comprises sending the first data unit to a second RAN node for transmission to the UE.

FIG. 2 depicts a method in accordance with particular embodiments, e.g. a method performed by a second Radio Access Network (RAN) node for transmitting a data unit to a user equipment (UE). The method 2 may be performed by a network node (e.g. the network node QQ110 or network node QQ300 as described later with reference to FIGS. 7 and 9 respectively). The method begins at step 202 with receiving, from a first RAN node, a request to send, to the second RAN node for transmission to the UE, a first data unit and/or one or more of a set of data units including the first data unit, and step 204 with selecting a process for the first RAN node to send at least the first data unit to the second RAN node for transmission to the UE. Next, step 206 comprises sending, to the first RAN node, a response to the request, wherein the request includes information identifying the selected process, and step 208 comprises receiving, from the first RAN node, at least the first data unit according to the selected process. Step 210 then comprises transmitting at least the first data unit to the UE.

Particular examples are now described.

Example embodiments may include the following steps:
1. The NG-RAN node to request a second NG-RAN node to perform XR QoS offloading, and/or split bearer, and/or PDCP Duplication.
2. The second NG-RAN node to determines, based on its own resource situation and/or the QoS requirement, a process for obtaining data units (e.g. SDUs/PDUs) from the first RAN node, e.g. to either perform XR QoS offloading (e.g. to setup the required QoS flow and map it to a DRB), or perform Split bearer, or perform PDCP duplication.
3. The second NG-RAN node can also determine when the QoS offload is to be performed if, for this given QoS flow, split bearer and/or duplication is selected.
4. The second NG-RAN node responds to the first NG-RAN node with the decision, and the user plane data tunnel is set up accordingly.

In one example, the NG-RAN node may request the second NG-RAN node to perform XR offloading. In some examples, it may only indicate that the XR offloading is required and the related QoS requirement of the XR PDU Set QoS flows, such as the PDU Set Delay Budget (PSDB) and the PDU Set Error Rate (PSER). The first NG-RAN node could additionally indicate one or more fields indicating the PDU set size associated to the given QoS or PSDB, e.g. the number of bits or bytes which must be delivered within the PSDB. These fields could represent, for example, the minimum size, maximum size, average size and/or the size of the data burst the first node is expected to send to the second node for transmitting to the UE. The information may also include the periodicity, e.g. how often the first node may be sending this amount of data to the second node.

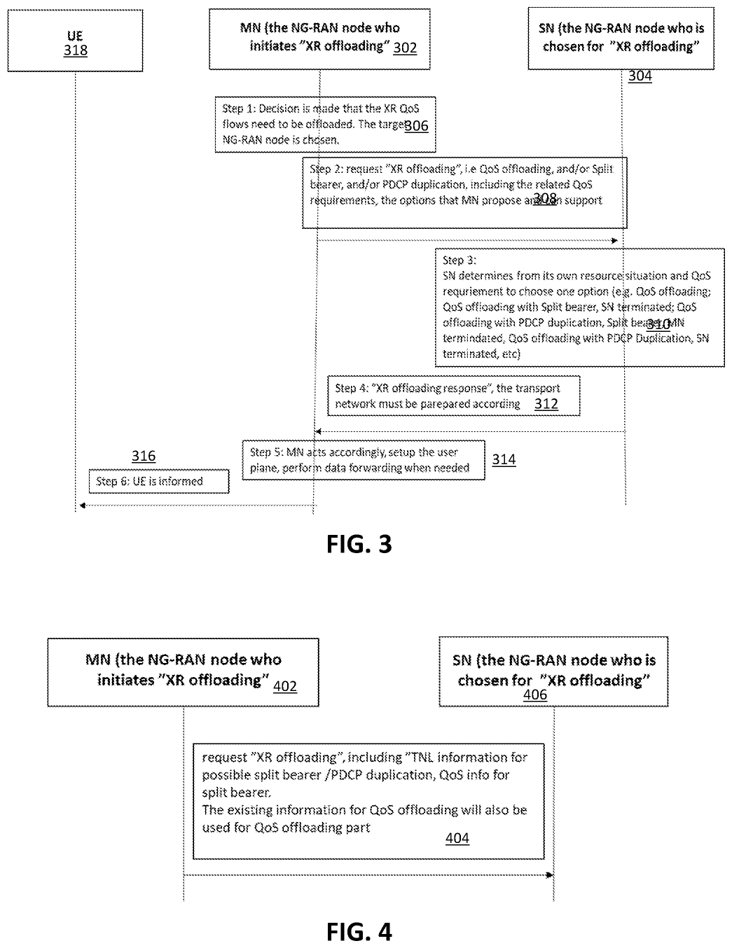

FIG. 3 shows an example of an overall signaling flow for the “XR offloading” from one RAN node 302 to another (e.g. from first 302 to second RAN node 304). In this Figure, the MN may be the first RAN node 302 and the SN may be the second RAN node 304. However, in other examples of this and other embodiments, this may be reversed, e.g. the first RAN node may be the SN and the second RAN node may be the MN.

In FIG. 3, in step 306, first RAN node 302 decides XR QoS flows should be offloaded, and chooses target RAN node (second RAN node 304). In step 308, first RAN node 302 requests XR offloading from the second RAN node 304. In step 310, the second RAN node chooses an option from its own resource situation and QoS requirements. In step 312, second RAN node 304 sends an XR offloading response to the first RAN node 302. In step 314, first RAN node 302 performs appropriate actions, e.g. set up the user plane, performing data forwarding when needed, etc. In step 316, first RAN node 302 informs UE 318.

The data unit (e.g. XR PDU) set may for example represent a user data marking, and in some examples all packets or data units (e.g. of a service for a UE) should be in the same QoS flow and using the same Tunnel. In case however the PDU sets are signalled in different XR QoS flows using different tunnels, the receiver of the data units from multiple QoS flows (e.g. a PDCP layer or other entity within the first RAN node) may in some examples verify any marking for the association of the PDU Sets QoS flows. Such marking can for example be based on a identifier to pair the received QoS flows together to follow the same treatment by the receiver and during the XR offloading.

During the XR offloading, the sender NG-RAN node (e.g. first RAN node) may in some examples also include TNL address in case the data units are shared to the second RAN node using Split bearer and/or PDCP duplication. The second RAN node may in some examples be aware of the XR offloading, and may perform a pure QoS offloading, or pure split bearer, or choose to perform QoS offloading with Split bearer. FIG. 4 shows an example of a MN (or first RAN node) 402 sending in an “XR offloading Information” message 404 the TNL info to the SN (or second RAN node) 406, QoS for the split bearer, and also the existing QoS offloading parameters. SN (or second RAN node) 406 understands the “XR offloading” is requested and determines the options.

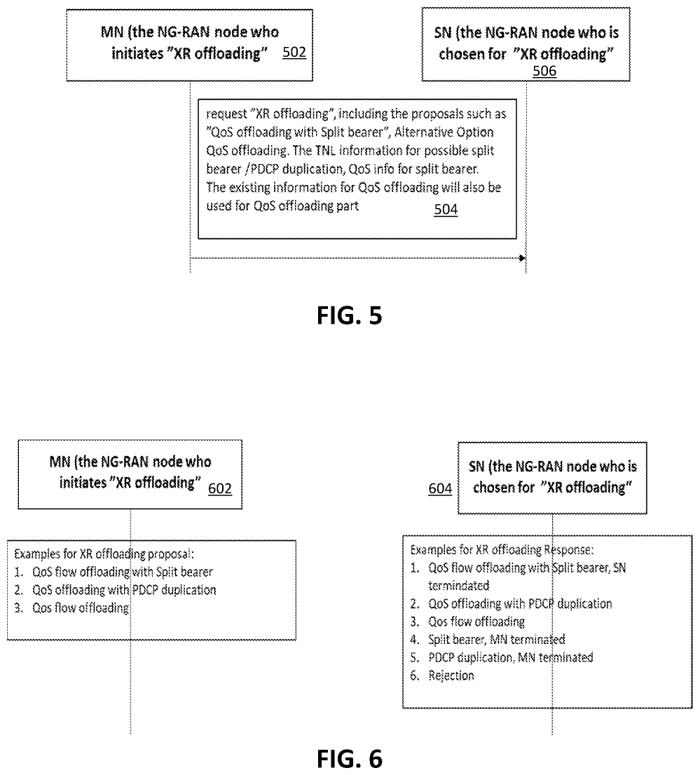

FIG. 5 shows another example of a first RAN node sending an offloading message to a second RAN node. In this example, the first RAN node (or MN) 502 indicates in an “XR offloading” request 504 to the second RAN node (or SN) 506 the supported options/proposals for the XR offloading, e.g. QoS offloading with split bearer setup, the TNL information for the split bearer is provided and how the QoS requirement can be divided. If the second RAN node decides to go for this option, it will perform QoS offloading (e.g. to setup the QoS and perform DRB mapping) and at the same time setup split bearer. It can decide if PDCP resides in first or second RAN node (e.g. in MN or SN), but to simplify the procedure, it may be easier if the PDCP resides in this case in SN/second RAN node. In the response, the second RAN node confirms the TNL for QoS offloading, and also for split bearer.

FIG. 6 shows examples of XR offloading proposals at a first RAN node (or MN) 602 and examples of XR offloading responses at a second RAN node (or SN) 604. In this example, instead of split bearer, PDCP duplication can be used, so the QoS flow is offloaded to the second RAN node 604, and at the same time PDCP duplication is setup. The first RAN node 602 can indicate one or more supported options.

In some examples of this disclosure, the MN or first RAN node may in the “SN Addition procedure” or the “MN-initiated SN Modification procedure”, include a “XR offload information”. The “XR offload information” may include a new Xn-U tunnel used at the SN/second RAN node to prepare the split bearer or PDCP duplication at the SN/second RAN node side; an indication for QoS offloading, and the QoS requirement if the split bearer is used. The existing information for QoS offloading may be signaled in some examples. Tables 9.1.2.1, 9.2.1.5, 9.2.1.7, 9.1.2.5, and 9.2.3.X (new) below show examples of message details in example implementations. Relevant parts are underlined.

In some examples, the second RAN node may determine, based on its own resource situation and/or the QoS/PDB requirement, determine the process to use for obtaining data units from the first RAN node, e.g. to either perform pure QoS offloading (e.g. setup the required QoS flow and map it to a DRB), or perform Split bearer, or perform PDCP duplication, or QoS offload with Split bearer. The second RAN node may respond to the first RAN node with the decision, and the user plane data tunnel is set up accordingly. In this decision, the second RAN node may in some examples indicate to the first node the amount of data it can handle given the indicated PSDB/PDB/QoS requirements. The second node may accept the request, if it was provided, indicated by the first node (e.g. the number of bits or bytes which must be delivered within the PSDB with a certain periodicity), or it may indicate a different value.

In some examples, the second RAN node may in the acknowledge/response of the request (e.g. “SN Addition procedure” or the “MN-initiated SN Modification procedure”) include an “XR offloading response”. The “XR offloading Response” may include what will be setup and the additional information needed. For example, if only QoS offloading is performed, it will indicate so the first node could clean up early allocated TNL for the split bearer. If only Split bearer is performed, it will indicate so MN could be aware that the QoS offloading is not performed. If PDCP duplication is performed, the PDCP duplication configuration and activation information will be sent. Tables 9.1.2.2, 9.1.2.6, 9.1.2.6 and 9.2.1.8, 9.2.3.X (new) below show examples of message details in example implementations. Relevant parts are underlined. Note that similar examples may apply in some examples when Dual Connectivity is set up already and PDU sessions and QoS flows are setup at SN/second RAN node. Then, the XR offloading is performed towards MN/first RAN node.

For each PDU set the first RAN node receives and identifies, in some examples, the first RAN node may evaluate whether it can transmit the PDU set within the PSDB/PDB. If it can meet the requirements, the first RAN node might not use the second RAN node. However, if the first node cannot meet the requirements, it may transmit the data to the UE via the second node according to the configuration agreed by the nodes, for example according to examples disclosed herein, for transmission of the data to the UE by the second node. In some examples, if the first node assesses the second node can meet the requirements, it may send the PDU set to the UE via the second node. If neither the first node nor the second node can meet the requirements by themselves, the first node may assess whether the requirements can be met by transmitting part of the PDU set via the first node and another part of the PDU set via the second node.

Below are provided the above-mentioned tables for example implementations.

### 9.1.2.1 S-Node Addition Request

This message is sent by the M-NG-RAN node to the S-NG-RAN node to request the preparation of resources for dual connectivity operation for a specific UE.

Direction: M-NG-RAN node→S-NG-RAN node.

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | reject |
| M-NG-RAN node | M | | NG-RAN | Allocated at the | YES | reject |
| UE XnAP ID | | | node UE | M-NG-RAN node | | |
| | | | XnAP ID | | | |
| | | | 9.2.3.16 | | | |
| UE Security | M | | 9.2.3.49 | | YES | reject |
| Capabilities | | | | | | |
| S-NG-RAN node | M | | 9.2.3.51 | | YES | reject |
| Security Key | | | | | | |
| S-NG-RAN node | M | | UE | The UE | YES | reject |
| UE Aggregate | | | Aggregate | Aggregate | | |
| Maximum Bit | | | Maximum Bit | Maximum Bit Rate | | |
| Rate | | | Rate | is split into M-NG- | | |
| | | | 9.2.3.17 | RAN node UE | | |
| | | | | Aggregate | | |
| | | | | Maximum Bit Rate | | |
| | | | | and S-NG-RAN | | |
| | | | | node UE | | |
| | | | | Aggregate | | |
| | | | | Maximum Bit Rate | | |
| | | | | which are | | |
| | | | | enforced by M- | | |
| | | | | NG-RAN node | | |
| | | | | and S-NG-RAN | | |
| | | | | node respectively. | | |
| Selected PLMN | O | | PLMN | The selected | YES | ignore |
| | | | Identity | PLMN of the SCG | | |
| | | | 9.2.2.4 | in the S-NG-RAN | | |
| | | | | node. | | |
| Mobility | O | | 9.2.3.53 | | YES | ignore |
| Restriction List | | | | | | |
| Index to | O | | 9.2.3.23 | | YES | reject |
| RAT/Frequency | | | | | | |
| Selection Priority | | | | | | |
| PDU Session | | 1 | | | YES | reject |
| Resources To | | | | | | |
| Be Added List | | | | | | |
| >PDU Session | | 1 . . . | | NOTE: If neither | — | |
| Resources To | | <maxno | | the | | |
| Be Added Item | | ofPDUS | | PDU Session | | |
| | | essions> | | Resource Setup | | |
| | | | | Info - SN | | |
| | | | | terminated IE | | |
| | | | | nor the | | |
| | | | | PDU Session | | |
| | | | | Resource Setup | | |
| | | | | Info - MN | | |
| | | | | terminated IE | | |
| | | | | is present in a | | |
| | | | | PDU Session | | |
| | | | | Resources To Be | | |
| | | | | Added Item IE, | | |
| | | | | abnormal | | |
| | | | | conditions as | | |
| | | | | specified in | | |
| | | | | clause 8.3.1.4 | | |
| | | | | apply. | | |
| >>PDU | M | | 9.2.3.18 | | — | |
| Session ID | | | | | | |
| >>S-NSSAI | M | | 9.2.3.21 | | — | |
| >>S-NG-RAN | O | | PDU | | — | |
| node PDU | | | Session | | | |
| Session | | | Aggregate | | | |
| Aggregate | | | Maximum Bit | | | |
| Maximum Bit | | | Rate | | | |
| Rate | | | 9.2.3.69 | | | |
| >>PDU | O | | 9.2.1.5 | | — | |
| Session | | | | | | |
| Resource | | | | | | |
| Setup Info - | | | | | | |
| SN terminated | | | | | | |
| >>PDU | O | | 9.2.1.7 | | — | |
| Session | | | | | | |
| Resource | | | | | | |
| Setup Info - | | | | | | |
| MN terminated | | | | | | |
| XR offload | O | | ENUMERAT | This IE indicates | | |
| information | | | ED(Request | XR offloading | | |
| | | | ed, . . . ) | request | | |
| M-NG-RAN node | M | | OCTET | Includes the CG- | YES | reject |
| to S-NG-RAN | | | STRING | Configinfo | | |
| node Container | | | | message as | | |
| | | | | defined in | | |
| | | | | subclause 11.2.2 | | |
| | | | | of TS 38.331 [10] | | |
| S-NG-RAN node | O | | NG-RAN | Allocated at the | YES | reject |
| UE XnAP ID | | | node UE | S-NG-RAN node | | |
| | | | XnAP ID | | | |
| | | | 9.2.3.16 | | | |
| Expected UE | O | | 9.2.3.81 | | YES | ignore |
| Behaviour | | | | | | |
| Requested Split | O | | ENUMERAT | Indicates that | YES | reject |
| SRBs | | | ED (srb1, | resources for Split | | |
| | | | srb2, | SRBs are | | |
| | | | srb1&2, . . . ) | requested. | | |
| PCell ID | O | | Global NG- | | YES | reject |
| | | | RAN Cell | | | |
| | | | Identity | | | |
| | | | 9.2.2.27 | | | |
| Desired Activity | O | | 9.2.3.77 | | YES | ignore |
| Notification Level | | | | | | |
| Available DRB | C- | | DRB List | Indicates the list | YES | reject |
| IDs | ifSNtermin | | 9.2.1.29 | of DRB IDs that | | |
| | ated | | | the S-NG-RAN | | |
| | | | | node may use for | | |
| | | | | SN-terminated | | |
| | | | | bearers. | | |

//other rows omitted

| Range bound | Explanation |
|---|---|
| maxnoofPDUSessions | Maximum no. of PDU sessions. Value is 256 |
| ifSNterminated | This IE shall be present if there is at least one PDU Session |
| | Resource Setup Info - SN terminated in the PDU Session |
| | Resources To Be Added List IE. |

### 9.2.1.5 PDU Session Resource Setup Info-SN Terminated

This IE contains information for the addition of S-NG-RAN node resources related to a PDU session for DRBs configured with an SN terminated bearer option.

| | | | IE type and | Semantics | | Assigned |
|---|---|---|---|---|---|---|
| IE/Group Name | Presence | Range | reference | description | Criticality | Criticality |
| UL NG-U UP TNL | M | | UP Transport | UPF endpoint of | — | |
| Information at UPF | | | Layer | the NG-U | | |
| | | | Information | transport bearer. | | |
| | | | 9.2.3.30 | For delivery of UL | | |
| | | | | PDUs | | |
| PDU Session Type | M | | 9.2.3.19 | | — | |
| Network Instance | O | | 9.2.3.85 | This IE shall be | — | |
| | | | | ignored if the | | |
| | | | | Common Network | | |
| | | | | Instance IE is | | |
| | | | | present. | | |
| QoS Flows To Be | | 1 | | | — | |
| Setup List | | | | | | |
| >QoS Flow To Be | | 1 . . . | | | — | |
| Setup Item | | <maxnoof | | | | |
| | | QoSFlows | | | | |
| | | > | | | | |
| >>QoS Flow | M | | 9.2.3.10 | | — | |
| Identifier | | | | | | |
| >>QoS Flow Level | M | | 9.2.3.5 | For GBR QoS | — | |
| QoS Parameters | | | | flows, this IE | | |
| | | | | contains GBR | | |
| | | | | QoS flow | | |
| | | | | information as | | |
| | | | | received at NG-C | | |
| >>Offered GBR QoS | O | | GBR QoS | This IE contains | — | |
| Flow Information | | | Flow | M-Node offered | | |
| | | | Information | GBR QoS Flow | | |
| | | | 9.2.3.6 | Information. | | |
| >>TSC Traffic | O | | 9.2.3.114 | | YES | ignore |
| Characteristics | | | | | | |
| >>Redundant QoS | O | | 9.2.3.118 | | YES | ignore |
| Flow Indicator | | | | | | |
| >>XR QoS Flow | O | | 9.2.3.X | | YES | ignore |
| parameters | | | | | | |
| Data Forwarding and | O | | 9.2.1.17 | | — | |
| Offloading Info from | | | | | | |
| source NG-RAN node | | | | | | |
| Security Indication | O | | 9.2.3.52 | | — | |
| Security Result | O | | 9.2.3.67 | Indicates security | YES | reject |
| | | | | activation status | | |
| | | | | in MN. | | |
| Common Network | O | | 9.2.3.92 | | YES | ignore |
| Instance | | | | | | |
| Default DRB Allowed | O | | 9.2.3.93 | | YES | ignore |
| Split Session Indicator | O | | 9.2.3.94 | | YES | reject |
| Non-GBR Resources | O | | 9.2.3.98 | | YES | ignore |
| Offered | | | | | | |
| Redundant UL NG-U | O | | UP Transport | UPF endpoint of | YES | ignore |
| UP TNL Information at | | | Layer | the NG-U | | |
| UPF | | | Information | transport bearer. | | |
| | | | 9.2.3.30 | For delivery of UL | | |
| | | | | PDUs for the | | |
| | | | | redundant | | |
| | | | | transmission. | | |
| Redundant Common | O | | Common | | YES | ignore |
| Network Instance | | | Network | | | |
| | | | Instance | | | |
| | | | 9.2.3.92 | | | |
| Redundant PDU | O | | 9.2.3.112 | | YES | ignore |
| Session Information | | | | | | |

| Range bound | Explanation |
|---|---|
| maxnoofQoSFlows | Maximum no. of QoS flows. Value is 64 |

### 9.2.1.7 PDU Session Resource Setup Info-MN Terminated

This IE contains information for the addition of S-NG-RAN node resources related to a PDU session for DRBs configured with an MN terminated bearer option.

| | | | IE type and | Semantics | | Assigned |
|---|---|---|---|---|---|---|
| IE/Group Name | Presence | Range | reference | description | Criticality | Criticality |
| PDU Session Type | M | | 9.2.3.19 | | — | |
| DRBs To Be Setup | | 1 | | | — | |
| List | | | | | | |
| >DRBs to Be | | 1 . . . | | | — | |
| Setup Item | | <maxnoofDRBs> | | | | |
| >>DRB ID | M | | 9.2.3.33 | | — | |
| >>MN UL PDCP | M | | UP Transport | M-NG-RAN node | — | |
| UP TNL | | | Parameters | endpoint(s) of a | | |
| Information | | | 9.2.3.76 | DRB's Xn-U | | |
| | | | | transport bearer at | | |
| | | | | its PDCP resource. | | |
| | | | | For delivery of UL | | |
| | | | | PDUs. | | |
| >>RLC Mode | M | | 9.2.3.28 | Indicates the RLC | — | |
| | | | | mode to be used in | | |
| | | | | the assisting node. | | |
| >>UL | O | | 9.2.3.75 | Information about UL | — | |
| Configuration | | | | usage in the S-NG- | | |
| | | | | RAN node. This IE | | |
| | | | | is used when the | | |
| | | | | concerned DRB has | | |
| | | | | both MCG resource | | |
| | | | | and SCG resource | | |
| | | | | configured i.e. the | | |
| | | | | concerned DRB is | | |
| | | | | configured as split | | |
| | | | | bearer. | | |
| >>DRB QoS | M | | QoS Flow | | — | |
| | | | Level QoS | | | |
| | | | Parameters | | | |
| | | | 9.2.3.5 | | | |
| >>PDCP SN | O | | 9.2.3.63 | Indicates the PDCP | — | |
| Length | | | | SN length of the | | |
| | | | | DRB. | | |
| >>secondary MN | O | | UP Transport | M-NG-RAN node | — | |
| UL PDCP UP | | | Parameters | endpoint(s) of a | | |
| TNL Information | | | 9.2.3.76 | DRB's Xn transport | | |
| | | | | bearer at its PDCP | | |
| | | | | resource. For | | |
| | | | | delivery of UL PDUs | | |
| | | | | in case of PDCP | | |
| | | | | duplication. | | |
| >>Duplication | O | | 9.2.3.71 | Information on the | — | |
| Activation | | | | initial state of UL | | |
| | | | | PDCP duplication. | | |
| | | | | This IE is ignored if | | |
| | | | | the RLC Duplication | | |
| | | | | Information IE is | | |
| | | | | present. | | |
| >>QoS Flows | | 1 | | | — | |
| Mapped To DRB | | | | | | |
| List | | | | | | |
| >>>QoS Flows | | 1 . . . | | | — | |
| Mapped To | | <maxnoofQoSFlows> | | | | |
| DRB Item | | | | | | |
| >>>>QoS Flow | M | | 9.2.3.10 | | — | |
| Identifier | | | | | | |
| >>>>QoS Flow | M | | 9.2.3.5 | | — | |
| Level QoS | | | | | | |
| Parameters | | | | | | |
| >>>>QoS Flow | O | | 9.2.3.79 | | — | |
| Mapping | | | | | | |
| Indication | | | | | | |
| >>>>TSC | O | | 9.2.3.114 | | YES | ignore |
| Traffic | | | | | | |
| Characteristics | | | | | | |
| >>XR QoS | O | | 9.2.3.X | | YES | ignore |
| Flow | | | | | | |
| parameters | | | | | | |
| >>Additional | | 0 . . . 1 | | | YES | Ignore |
| PDCP | | | | | | |
| Duplication TNL | | | | | | |
| List | | | | | | |
| >>>Additional | | 1 . . . | | | — | |
| PDCP | | <maxnoofAdditionalPDCPDuplicationTNL> | | | | |
| Duplication | | | | | | |
| TNL Item | | | | | | |
| >>>>Additional | M | | UP Transport | M-NG-RAN node | — | |
| PDCP | | | Parameters | endpoint(s) of a | | |
| Duplication UP | | | 9.2.3.76 | DRB's Xn transport | | |
| TNL | | | | bearer at its PDCP | | |
| Information | | | | resource. For | | |
| | | | | delivery of UL PDUs | | |
| | | | | in case of additional | | |
| | | | | PDCP duplication. | | |
| >>RLC | O | | 9.2.3.111 | | YES | ignore |
| Duplication | | | | | | |
| Information | | | | | | |

| Range bound | Explanation |
|---|---|
| maxnoofDRBs | Maximum no. of DRBs allowed towards one UE. Value is |
| | 32. |
| maxnoofQoSFlows | Maximum no. of QoS flows allowed within one PDU |
| | session. Value is 64. |
| maxnoofAdditionalPDCPDuplicationTNL | Maximum no. of additional PDCP Duplication TNL. Value is |
| | 2. |

### 9.2.3.X XR QoS Flow Parameters

This IE indicates XR QoS Flow Parameters for a PDU Set.

| | | | IE type | |
|---|---|---|---|---|
| | | | and | |
| IE/Group Name | Presence | Range | reference | Semantics description |
| Guaranteed Flow Bit Rate | O | Z | Bit Rate | Z |
| Downlink | | | 9.2.3.4 | |
| Guaranteed Flow Bit Rate | O | | Bit Rate | |
| Uplink | | | 9.2.3.4 | |
| PDU Set Packet Delay | O | | 9.2.3.12 | |
| Budget | | | | |
| PDU Set packet Error | O | | 9.2.3.13 | |
| Rate | | | | |

### 9.1.2.5 S-Node Modification Request

This message is sent by the M-NG-RAN node to the S-NG-RAN node to either request the preparation to modify S-NG-RAN node resources for a specific UE, or to query for the current SCG configuration, or to provide the S-RLF-related information to the S-NG-RAN node.

Direction: M-NG-RAN node→S-NG-RAN node.

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | reject |
| M-NG-RAN node UE | M | | NG-RAN | Allocated at the | YES | reject |
| XnAP ID | | | node UE | M-NG-RAN node | | |
| | | | XnAP ID | | | |
| | | | 9.2.3.16 | | | |
| S-NG-RAN node UE | M | | NG-RAN | Allocated at the | YES | reject |
| XnAP ID | | | node UE | S-NG-RAN node | | |
| | | | XnAP ID | | | |
| | | | 9.2.3.16 | | | |
| Cause | M | | 9.2.3.2 | | YES | ignore |
| PDCP Change | O | | 9.2.3.74 | | YES | ignore |
| Indication | | | | | | |
| Selected PLMN | O | | PLMN | The selected | YES | ignore |
| | | | Identity | PLMN of the | | |
| | | | 9.2.2.4 | SCG in the S- | | |
| | | | | NG-RAN node. | | |
| Mobility Restriction List | O | | 9.2.3.53 | | YES | ignore |
| SCG Configuration | O | | 9.2.3.27 | | YES | ignore |
| Query | | | | | | |
| UE Context | | 0 . . . 1 | | | YES | reject |
| Information | | | | | | |
| >UE Security | O | | 9.2.3.49 | | — | |
| Capabilities | | | | | | |
| >S-NG-RAN node | O | | 9.2.3.51 | | — | |
| Security Key | | | | | | |
| >S-NG-RAN node UE | O | | UE | | — | |
| Aggregate Maximum | | | Aggregate | | | |
| Bit Rate | | | Maximum | | | |
| | | | Bit Rate | | | |
| | | | 9.2.3.17 | | | |
| >Index to | O | | 9.2.3.23 | | — | |
| RAT/Frequency | | | | | | |
| Selection Priority | | | | | | |
| >Lower Layer | O | | 9.2.3.60 | | — | |
| presence status | | | | | | |
| change | | | | | | |
| >PDU Session | | 0 . . . 1 | | | — | |
| Resources To Be | | | | | | |
| Added List | | | | | | |
| >>PDU Session | | 1 . . . | | NOTE: If neither | — | |
| Resources To Be | | <maxnoofPDUSessions> | | the | | |
| Added Item | | | | PDU Session | | |
| | | | | Resource Setup | | |
| | | | | Info - SN | | |
| | | | | terminated IE | | |
| | | | | nor the | | |
| | | | | PDU Session | | |
| | | | | Resource Setup | | |
| | | | | Info - MN | | |
| | | | | terminated IE | | |
| | | | | is present in a | | |
| | | | | PDU Session | | |
| | | | | Resources To Be | | |
| | | | | Added Item IE, | | |
| | | | | abnormal | | |
| | | | | conditions as | | |
| | | | | specified in | | |
| | | | | clause 8.3.3.4 | | |
| | | | | apply. | | |
| >>>PDU Session | M | | 9.2.3.18 | | — | |
| ID | | | | | | |
| >>>S-NSSAI | M | | 9.2.3.21 | | — | |
| >>>S-NG-RAN | O | | PDU | | — | |
| node PDU Session | | | Session | | | |
| Aggregate | | | Aggregate | | | |
| Maximum Bit Rate | | | Maximum | | | |
| | | | Bit Rate | | | |
| | | | 9.2.3.69 | | | |
| >>>PDU Session | O | | 9.2.1.5 | | — | |
| Resource Setup | | | | | | |
| Info - SN | | | | | | |
| terminated | | | | | | |
| >>>PDU Session | O | | 9.2.1.7 | | — | |
| Resource Setup | | | | | | |
| Info - MN | | | | | | |
| terminated | | | | | | |
| >>>PDU Session | O | | Expected | Expected UE | YES | ignore |
| Expected UE | | | UE | Activity | | |
| Activity Behaviour | | | Activity | Behaviour for the | | |
| | | | Behaviour | PDU Session. | | |
| | | | 9.2.3.82 | | | |
| XR offload | O | | ENUMERATED(Requested, . . .) | This IE | | |
| information | | | | indicates | | |
| | | | | XR offloading | | |
| | | | | request | | |
| >PDU Session | | 0 . . . 1 | | | — | |
| Resources To Be | | | | | | |
| Modified List | | | | | | |
| >>PDU Session | | 1 . . . | | NOTE: If neither | — | |
| Resources To Be | | <maxnoofPDUSessions> | | the | | |
| Modified Item | | | | PDU Session | | |
| | | | | Resource | | |
| | | | | Modification | | |
| | | | | Info - SN | | |
| | | | | terminated IE | | |
| | | | | nor the | | |
| | | | | PDU Session | | |
| | | | | Resource | | |
| | | | | Modification | | |
| | | | | Info - MN | | |
| | | | | terminated IE | | |
| | | | | is present in a | | |
| | | | | PDU Session | | |
| | | | | Resources To Be | | |
| | | | | Modified Item IE, | | |
| | | | | abnormal | | |
| | | | | conditions as | | |
| | | | | specified in | | |
| | | | | clause 8.3.3.4 | | |
| | | | | apply. | | |
| >>>PDU Session | M | | 9.2.3.18 | | — | |
| ID | | | | | | |
| >>>S-NG-RAN | O | | PDU | | — | |
| node PDU Session | | | Session | | | |
| Aggregate | | | Aggregate | | | |
| Maximum Bit Rate | | | Maximum | | | |
| | | | Bit Rate | | | |
| | | | 9.2.3.69 | | | |
| >>>PDU Session | O | | 9.2.1.9 | | — | |
| Resource | | | | | | |
| Modification Info - | | | | | | |
| SN terminated | | | | | | |
| >>>PDU Session | O | | 9.2.1.11 | | — | |
| Resource | | | | | | |
| Modification Info - | | | | | | |
| MN terminated | | | | | | |
| >>>S-NSSAI | O | | 9.2.3.21 | | YES | reject |
| >>>PDU Session | O | | Expected | Expected UE | YES | ignore |
| Expected UE | | | UE | Activity | | |
| Activity Behaviour | | | Activity | Behaviour for the | | |
| | | | Behaviour | PDU Session. | | |
| | | | 9.2.3.82 | | | |
| XR offload | O | | ENUMERATED(Requested, . . .) | This IE | | |
| information | | | | indicates | | |
| | | | | XR offloading | | |
| | | | | request | | |
| >PDU Session | O | | PDU | | — | |
| Resources To Be | | | session | | | |
| Released List | | | List with | | | |
| | | | Cause | | | |
| | | | 9.2.1.26 | | | |
| M-NG-RAN node to S- | O | | OCTET | Includes the CG- | YES | ignore |
| NG-RAN node | | | STRING | ConfigInfo | | |
| Container | | | | message as | | |
| | | | | defined in | | |
| | | | | subclause | | |
| | | | | 11.2.2. of TS | | |
| | | | | 38.331 [10]. | | |
| Requested Split SRBs | O | | ENUMERATED | Indicates that | YES | ignore |
| | | | (srb1, srb2, | resources for | | |
| | | | srb1&2, . . .) | Split SRBs are | | |
| | | | | requested. | | |
| Requested Split SRBs | O | | ENUMERATED | Indicates that | YES | ignore |
| release | | | (srb1, srb2, | resources for | | |
| | | | srb1&2, . . .) | Split SRBs are | | |
| | | | | requested to be | | |
| | | | | released. | | |

//other rows omitted

| Range bound | Explanation |
|---|---|
| maxnoofPDUSessions | Maximum no. of PDU sessions. Value is 256 |
| maxnoofPSCellCandidate | Maximum no. of PSCell candidates. Value is 8 |
| maxnoofTargetSNs | Maximum no. of the target S-NG-RAN nodes. Value is 8 |

### 9.1.2.2 S-Node Addition Request Acknowledge

This message is sent by the S-NG-RAN node to confirm the M-NG-RAN node about the S-NG-RAN node addition preparation.

Direction: S-NG-RAN node→M-NG-RAN node.

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | reject |
| M-NG-RAN node UE | M | | NG-RAN | Allocated at | YES | reject |
| XnAP ID | | | node UE | the M-NG- | | |
| | | | XnAP ID | RAN node | | |
| | | | 9.2.3.16 | | | |
| S-NG-RAN node UE | M | | NG-RAN | Allocated at | YES | reject |
| XnAP ID | | | node UE | the S-NG- | | |
| | | | XnAP ID | RAN node | | |
| | | | 9.2.3.16 | | | |
| PDU Session | | 1 | | | YES | ignore |
| Resources Admitted | | | | | | |
| To Be Added List | | | | | | |
| >PDU Session | | 1 . . . | | NOTE: If | — | |
| Resources | | <maxnoofPDUSessions> | | neither the | | |
| Admitted To Be | | | | PDU | | |
| Added Item | | | | Session | | |
| | | | | Resource | | |
| | | | | Setup | | |
| | | | | Response | | |
| | | | | Info - SN | | |
| | | | | terminated | | |
| | | | | IE | | |
| | | | | nor the | | |
| | | | | PDU | | |
| | | | | Session | | |
| | | | | Resource | | |
| | | | | Setup | | |
| | | | | Response | | |
| | | | | Info - MN | | |
| | | | | terminated | | |
| | | | | IE | | |
| | | | | is present in | | |
| | | | | a PDU | | |
| | | | | Session | | |
| | | | | Resources | | |
| | | | | Admitted to | | |
| | | | | be Added | | |
| | | | | Item IE, | | |
| | | | | abnormal | | |
| | | | | conditions | | |
| | | | | as specified | | |
| | | | | in clause | | |
| | | | | 8.3.1.4 | | |
| | | | | apply. | | |
| >>PDU Session ID | M | | 9.2.3.18 | | — | |
| >>PDU Session | O | | 9.2.1.6 | | — | |
| Resource Setup | | | | | | |
| Response Info - SN | | | | | | |
| terminated | | | | | | |
| >>PDU Session | O | | 9.2.1.8 | | — | |
| Resource Setup | | | | | | |
| Response Info - | | | | | | |
| MN terminated | | | | | | |
| >>XR Offloading | O | | ENUMERATED(offloaded, . . .) | This IE | | |
| Response | | | | indicates | | |
| | | | | that the | | |
| | | | | admitted | | |
| | | | | QoS flow is | | |
| | | | | for the | | |
| | | | | offloaded | | |
| | | | | XR traffic | | |
| PDU Session | O | | | | YES | ignore |
| Resources Not | | | | | | |
| Admitted List | | | | | | |
| >PDU Session | O | | PDU | | — | |
| Resources Not | | | Session | | | |
| Admitted List - SN | | | Resources | | | |
| terminated | | | Not | | | |
| | | | Admitted | | | |
| | | | List | | | |
| | | | 9.2.1.3 | | | |
| >PDU Session | O | | PDU | | — | |
| Resources Not | | | Session | | | |
| Admitted List - MN | | | Resources | | | |
| terminated | | | Not | | | |
| | | | Admitted | | | |
| | | | List | | | |
| | | | 9.2.1.3 | | | |
| S-NG-RAN node to M- | M | | OCTET | Includes the | YES | reject |
| NG-RAN node | | | STRING | CG-Config | | |
| Container | | | | message or | | |
| | | | | the CG- | | |
| | | | | CandidateList | | |
| | | | | message | | |
| | | | | as defined | | |
| | | | | in | | |
| | | | | subclause | | |
| | | | | 11.2.2 of | | |
| | | | | TS 38.331 | | |
| | | | | [10]. | | |
| Admitted Split SRBs | O | | ENUMERATED | Indicates | YES | reject |
| | | | (srb1, srb2, | admitted | | |
| | | | srb1&2, . . .) | SRBs | | |
| RRC Config Indication | O | | 9.2.3.72 | | YES | reject |
| Criticality Diagnostics | O | | 9.2.3.3 | | YES | ignore |
| Location Information | O | | Target Cell | Contains | YES | ignore |
| at S-NODE | | | Global ID | information | | |
| | | | 9.2.3.25 | to support | | |
| | | | | localisation | | |
| | | | | of the UE | | |
| MR-DC Resource | O | | 9.2.2.33 | Information | YES | ignore |
| Coordination | | | | used to | | |
| Information | | | | coordinate | | |
| | | | | resource | | |
| | | | | utilisation | | |
| | | | | between M- | | |
| | | | | NG-RAN | | |
| | | | | node and | | |
| | | | | S-NG-RAN | | |
| | | | | node. | | |
| Available fast MCG | O | | ENUMERATED | Indicates | YES | ignore |
| recovery via SRB3 | | | (true, . . .) | the fast | | |
| | | | | MCG | | |
| | | | | recovery via | | |
| | | | | SRB3 is | | |
| | | | | enabled. | | |
| Direct Forwarding | O | | ENUMERATED | Indicates | YES | ignore |
| Path Availability | | | (direct path | direct | | |
| | | | available, . . .) | forwarding | | |
| | | | | path is | | |
| | | | | available | | |
| | | | | between | | |
| | | | | the target | | |
| | | | | S-NG-RAN | | |
| | | | | node and | | |
| | | | | source NG- | | |
| | | | | RAN node | | |
| | | | | for intra- | | |
| | | | | system | | |
| | | | | handover or | | |
| | | | | between | | |
| | | | | the target | | |
| | | | | S-NG-RAN | | |
| | | | | node and | | |
| | | | | the source | | |
| | | | | SN. | | |
| SCG Activation Status | O | | 9.2.3.155 | | YES | ignore |
| Conditional PSCell | O | | | | YES | ignore |
| Addition Information | | | | | | |
| Acknowledge | | | | | | |
| >Candidate PSCell | | 1 | | | — | |
| List | | | | | | |
| >>Candidate | | 1 . . . | | | — | |
| PSCell Item | | <maxnoofPSCellCandidate> | | | | |
| >>>PSCell ID | M | | NR CGI | | — | |
| | | | 9.2.2.7 | | | |

| Range bound | Explanation |
|---|---|
| maxnoofPDUSessions | Maximum no. of PDU sessions. Value is 256 |
| maxnoofPSCellCandidate | Maximum no, of PSCell candidate. Value is 8 |

### 9.1.2.6 S-Node Modification Request Acknowledge

This message is sent by the S-NG-RAN node to confirm the M-NG-RAN node's request to modify the S-NG-RAN node resources for a specific UE.

Direction: S-NG-RAN node→M-NG-RAN node.

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.2.3.1 | | YES | reject |
| M-NG-RAN node UE | M | | NG-RAN | Allocated at the | YES | ignore |
| XnAP ID | | | node UE | M-NG-RAN | | |
| | | | XnAP ID | node | | |
| | | | 9.2.3.16 | | | |
| S-NG-RAN node UE | M | | NG-RAN | Allocated at the | YES | ignore |
| XnAP ID | | | node UE | S-NG-RAN | | |
| | | | XnAP ID | node | | |
| | | | 9.2.3.16 | | | |
| PDU Session | | 0 . . . 1 | | | YES | ignore |
| Resources Admitted | | | | | | |
| List | | | | | | |
| >PDU Session | | 0 . . . 1 | | | — | |
| Resources Admitted | | | | | | |
| To Be Added List | | | | | | |
| >>PDU Session | | 1 . . . | | NOTE: If neither | — | |
| Resources Admitted | | <maxnoofPDUSessions> | | the | | |
| To Be Added Item | | | | PDU Session | | |
| | | | | Resource Setup | | |
| | | | | Response Info - | | |
| | | | | SN terminated | | |
| | | | | IE | | |
| | | | | nor the | | |
| | | | | PDU Session | | |
| | | | | Resource Setup | | |
| | | | | Response Info - | | |
| | | | | MN terminated | | |
| | | | | IE | | |
| | | | | is present in a | | |
| | | | | PDU Session | | |
| | | | | Resources | | |
| | | | | Admitted To Be | | |
| | | | | Added Item IE, | | |
| | | | | abnormal | | |
| | | | | conditions as | | |
| | | | | specified in | | |
| | | | | clause 8.3.3.4 | | |
| | | | | apply. | | |
| >>>PDU Session ID | M | | 9.2.3.18 | | — | |
| >>>PDU Session | O | | 9.2.1.6 | | — | |
| Resource Setup | | | | | | |
| Response Info - SN | | | | | | |
| terminated | | | | | | |
| >>>PDU Session | O | | 9.2.1.8 | | — | |
| Resource Setup | | | | | | |
| Response Info - MN | | | | | | |
| terminated | | | | | | |
| >>XR Offloading | O | | ENUMERATED(offloaded, . . .) | This IE indicates | | |
| Response | | | | that the | | |
| | | | | admitted QoS | | |
| | | | | flow is for the | | |
| | | | | offloaded XR | | |
| | | | | traffic | | |
| >PDU Session | | 0 . . . 1 | | | — | |
| Resources Admitted | | | | | | |
| To Be Modified List | | | | | | |
| >>PDU Session | | 1 . . . | | NOTE: If neither | — | |
| Resources Admitted | | <maxnoofPDUSessions> | | the | | |
| To Be Modified Item | | | | PDU Session | | |
| | | | | Resource | | |
| | | | | Modification | | |
| | | | | Response Info - | | |
| | | | | SN terminated | | |
| | | | | IE | | |
| | | | | nor the | | |
| | | | | PDU Session | | |
| | | | | Resource | | |
| | | | | Modification | | |
| | | | | Response Info - | | |
| | | | | MN terminated | | |
| | | | | IE | | |
| | | | | is present in a | | |
| | | | | PDU Session | | |
| | | | | Resources | | |
| | | | | Admitted To Be | | |
| | | | | Modified Item | | |
| | | | | IE, abnormal | | |
| | | | | conditions as | | |
| | | | | specified in | | |
| | | | | clause 8.3.3.4 | | |
| | | | | apply. | | |
| >>>PDU Session ID | M | | 9.2.3.18 | | — | |
| >>>PDU Session | O | | 9.2.1.10 | | — | |
| Resource Modification | | | | | | |
| Response Info - SN | | | | | | |
| terminated | | | | | | |
| >>>PDU Session | O | | 9.2.1.12 | | — | |
| Resource Modification | | | | | | |
| Response Info - MN | | | | | | |
| terminated | | | | | | |
| >PDU Session | | 0 . . . 1 | | | — | |
| Resources Admitted | | | | | | |
| To Be Released List | | | | | | |
| >>PDU Session | O | | PDU | | — | |
| Resources admitted to | | | session | | | |
| be released List - SN | | | List with | | | |
| terminated | | | data | | | |
| | | | forwarding | | | |
| | | | request | | | |
| | | | info | | | |
| | | | 9.2.1.24 | | | |
| >>PDU Session | O | | PDU | | — | |
| Resources admitted to | | | session | | | |
| be released List - MN | | | List with | | | |
| terminated | | | data | | | |
| | | | Cause | | | |
| | | | 9.2.1.26 | | | |
| PDU Session | O | | PDU | | YES | ignore |
| Resources Not | | | session | | | |
| Admitted to be Added | | | List | | | |
| List | | | 9.2.1.27 | | | |
| S-NG-RAN node to M- | O | | OCTET | Includes the | YES | ignore |
| NG-RAN node | | | STRING | CG-Config | | |
| Container | | | | message or the | | |
| | | | | CG- | | |
| | | | | CandidateList | | |
| | | | | message as | | |
| | | | | defined in | | |
| | | | | subclause | | |
| | | | | 11.2.2 of TS | | |
| | | | | 38.331 [10]. | | |
| Admitted Split SRBs | O | | ENUMERATED | Indicates | YES | ignore |
| | | | (srb1, srb2, | admitted SRBs | | |
| | | | srb1&2, . . .) | | | |
| Admitted Split SRBs | O | | ENUMERATED | Indicates | YES | ignore |
| release | | | (srb1, srb2, | admitted SRBs | | |
| | | | srb1&2, . . .) | release | | |
| Criticality Diagnostics | O | | 9.2.3.3 | | YES | ignore |
| Location Information at | O | | Target | Contains | YES | ignore |
| S-NODE | | | Cell | information to | | |
| | | | Global ID | support | | |
| | | | 9.2.3.25 | localisation of | | |
| | | | | the UE | | |
| MR-DC Resource | O | | 9.2.2.33 | Information | YES | Ignore |
| Coordination | | | | used to | | |
| Information | | | | coordinate | | |
| | | | | resource | | |
| | | | | utilisation | | |
| | | | | between M-NG- | | |
| | | | | RAN node and | | |
| | | | | S-NG-RAN | | |
| | | | | node. | | |
| PDU Session | | 0 . . . 1 | | | YES | ignore |
| Resources with Data | | | | | | |
| Forwarding List | | | | | | |
| >PDU Session | M | | PDU | | — | |
| Resources with Data | | | session | | | |
| Forwarding List - SN | | | List with | | | |
| terminated | | | data | | | |
| | | | forwarding | | | |
| | | | request | | | |
| | | | info | | | |
| | | | 9.2.1.24 | | | |
| RRC Config Indication | O | | 9.2.3.72 | | YES | reject |
| Available fast MCG | O | | ENUMERATED | Indicates the | YES | ignore |
| recovery via SRB3 | | | (true, . . .) | fast MCG | | |
| | | | | recovery via | | |
| | | | | SRB3 | | |
| | | | | isenabled. | | |
| Release fast MCG | O | | ENUMERATED | Indicates the | YES | ignore |
| recovery via SRB3 | | | (true, . . .) | fast MCG | | |
| | | | | recovery via | | |
| | | | | SRB3 is | | |
| | | | | released. | | |
| Direct Forwarding Path | O | | ENUMERATED | Indicates direct | YES | ignore |
| Availability | | | (direct path | path is available | | |
| | | | available, . . .) | between the S- | | |
| | | | | NG-RAN node | | |
| | | | | and the target | | |
| | | | | NG-RAN node. | | |
| SCG UE History | O | | 9.2.3.151 | | YES | ignore |
| Information | | | | | | |
| SCG Activation Status | O | | 9.2.3.155 | | YES | ignore |
| Conditional PSCell | O | | | This IE may be | YES | ignore |
| Addition Information | | | | sent from the | | |
| Modification | | | | target SN. | | |
| Acknowledge | | | | | | |
| >Candidate PSCell | | 1 | | | — | |
| List | | | | | | |
| >>Candidate PSCell | | 1 . . . | | | — | |
| Item | | <maxnoofPSCellCandidate> | | | | |
| >>>PSCell ID | M | | NR CGI | | — | |
| | | | 9.2.2.7 | | | |

| Range bound | Explanation |
|---|---|
| maxnoofPDUSessions | Maximum no. of PDU sessions. Value is 256 |
| maxnoofPSCellCandidate | Maximum no. of PSCell candidates. Value is 8 |

### 9.2.1.6 PDU Session Resource Setup Response Info-SN Terminated

This IE contains the result of the addition of S-NG-RAN node resources related to a PDU session for DRBs configured with an SN terminated bearer option.

| | | | IE type and | Semantics | | Assigned |
|---|---|---|---|---|---|---|
| IE/Group Name | Presence | Range | reference | description | Criticality | Criticality |
| DL NG-U UP TNL | M | | UP Transport | S-NG-RAN | — | |
| Information at NG- | | | Layer | node endpoint | | |
| RAN | | | Information | of the NG | | |
| | | | 9.2.3.30 | transport | | |
| | | | | bearer. For | | |
| | | | | delivery of DL | | |
| | | | | PDUs. | | |
| DRBs To Be Setup | | 0 . . . 1 | | | — | |
| List | | | | | | |
| >DRBs to Be | | 1 . . . | | | — | |
| Setup Item | | <maxnoofDRBs> | | | | |
| >>DRB ID | M | | 9.2.3.33 | | — | |
| >>SN UL PDCP | M | | UP Transport | S-NG-RAN | — | |
| UP TNL | | | Parameters | node | | |
| Information | | | 9.2.3. 76 | endpoint(s) of | | |
| | | | | a DRB's Xn | | |
| | | | | transport | | |
| | | | | bearer at its | | |
| | | | | PDCP | | |
| | | | | resource. For | | |
| | | | | delivery of UL | | |
| | | | | PDUs. | | |
| >>DRB QoS | M | | QoS Flow | | — | |
| | | | Level QoS | | | |
| | | | Parameters | | | |
| | | | 9.2.3.5 | | | |
| >>PDCP SN | O | | 9.2.3.63 | Indicates the | — | |
| Length | | | | PDCP SN | | |
| | | | | length of the | | |
| | | | | DRB. | | |
| >>RLC Mode | M | | 9.2.3.28 | Indicates the | — | |
| | | | | RLC mode to | | |
| | | | | be used in the | | |
| | | | | assisting node. | | |
| >>secondary SN | O | | UP Transport | S-NG-RAN | — | |
| UL PDCP UP TNL | | | Parameters | node | | |
| Information | | | 9.2.3.76 | endpoint(s) of | | |
| | | | | a DRB's Xn | | |
| | | | | transport | | |
| | | | | bearer at its | | |
| | | | | PDCP | | |
| | | | | resource. For | | |
| | | | | delivery of UL | | |
| | | | | PDUs in case | | |
| | | | | of PDCP | | |
| | | | | duplication. | | |
| >>Duplication | O | | 9.2.3.71 | Information on | — | |
| Activation | | | | the initial state | | |
| | | | | of UL PDCP | | |
| | | | | duplication. | | |
| | | | | This IE is | | |
| | | | | ignored if the | | |
| | | | | RLC | | |
| | | | | Duplication | | |
| | | | | Information IE | | |
| | | | | is present. | | |
| >>UL | O | | 9.2.3.75 | Information | — | |
| Configuration | | | | about UL | | |
| | | | | usage in the | | |
| | | | | M-NG-RAN | | |
| | | | | node. This IE | | |
| | | | | is used when | | |
| | | | | the concerned | | |
| | | | | DRB has both | | |
| | | | | MCG | | |
| | | | | resource and | | |
| | | | | SCG resource | | |
| | | | | configured i.e. | | |
| | | | | the concerned | | |
| | | | | DRB is | | |
| | | | | configured as | | |
| | | | | split bearer. | | |
| >>QoS Flows | | 1 | | | — | |
| Mapped To DRB | | | | | | |
| List | | | | | | |
| >>>QoS Flows | | 1 . . . | | | — | |
| Mapped To DRB | | <maxnoofQoSFlows> | | | | |
| Item | | | | | | |
| >>>>QoS Flow | M | | 9.2.3.10 | | — | |
| Identifier | | | | | | |
| >>>>MCG | O | | GBR QoS | This IE | — | |
| requested GBR | | | Flow | contains GBR | | |
| QoS Flow | | | Information | QoS Flow | | |
| Information | | | 9.2.3.6 | Information | | |
| | | | | necessary for | | |
| | | | | the MCG part. | | |
| >>>>QoS Flow | O | | 9.2.3.79 | | — | |
| Mapping | | | | | | |
| Indication | | | | | | |
| >>>>Current | O | | Alternative | | YES | ignore |
| QoS | | | QoS | | | |
| Parameters Set | | | Parameters | | | |
| Index | | | Set Index | | | |
| | | | 9.2.3.103 | | | |
| >>>>Source DL | O | | Transport | Identifies the | YES | ignore |
| Forwarding IP | | | Layer Address | TNL address | | |
| Address | | | 9.2.3.29 | used by the | | |
| | | | | source node | | |
| | | | | for data | | |
| | | | | forwarding. | | |
| >>XR QoS Flow | O | | 9.2.3.X | | YES | ignore |
| parameters | | | | | | |
| >>Additional | | 0 . . .1 | | | YES | Ignore |
| PDCP | | | | | | |
| Duplication TNL | | | | | | |
| List | | | | | | |
| >>>Additional | | 1 . . . | | | — | |
| PDCP | | <maxnoofAdditionalPDCPDuplicationTNL> | | | | |
| Duplication TNL | | | | | | |
| Item | | | | | | |
| >>>>Additional | M | | UP Transport | S-NG-RAN | — | |
| PDCP | | | Parameters | node | | |
| Duplication UP | | | 9.2.3.76 | endpoint(s) of | | |
| TNL Information | | | | a DRB's Xn | | |
| | | | | transport | | |
| | | | | bearer at its | | |
| | | | | PDCP | | |
| | | | | resource. For | | |
| | | | | delivery of UL | | |
| | | | | PDUs in case | | |
| | | | | of additional | | |
| | | | | PDCP | | |
| | | | | duplication. | | |
| >>RLC | O | | 9.2.3.111 | | — | |
| Duplication | | | | | | |
| Information | | | | | | |
| Data Forwarding Info | O | | 9.2.1.16 | | — | |
| from target NG-RAN | | | | | | |
| node | | | | | | |
| QoS Flows Not | O | | QoS Flow List | | — | |
| Admitted List | | | with Cause | | | |
| | | | 9.2.1.4 | | | |
| Security Result | O | | 9.2.3.67 | | — | |
| DRB IDs taken into | O | | DRB List | Indicating the | YES | reject |
| use | | | 9.2.1.29 | DRB IDs | | |
| | | | | taken into use | | |
| | | | | by the target | | |
| | | | | NG-RAN | | |
| | | | | node, as | | |
| | | | | specified in | | |
| | | | | TS 37.340 [8]. | | |
| Redundant DL NG-U | O | | UP Transport | S-NG-RAN | YES | ignore |
| UP TNL Information | | | Layer | node endpoint | | |
| at NG-RAN | | | Information | of the NG | | |
| | | | 9.2.3.30 | transport | | |
| | | | | bearer. For | | |
| | | | | delivery of DL | | |
| | | | | PDUs for the | | |
| | | | | redundant | | |
| | | | | transmission. | | |
| Used RSN | O | | Redundant | | YES | ignore |
| Information | | | PDU Session | | | |
| | | | Information | | | |
| | | | 9.2.3.112 | | | |

| Range bound | Explanation |
|---|---|
| maxnoofDRBs | Maximum no. of DRBs allowed towards one UE. Value is |
| | 32. |
| maxnoofQoSFlows | Maximum no. of QoS flows. Value is 64 |
| maxnoofAdditionalPDCPDuplicationTNL | Maximum no. of additional PDCP Duplication TNL. Value is |
| | 2. |

### 9.2.1.8 PDU Session Resource Setup Response Info-MN Terminated

This IE contains the result of the addition of S-NG-RAN node resources related to a PDU session for DRBs configured with an MN terminated bearer option.

| | | | IE type | | | |
|---|---|---|---|---|---|---|
| | | | and | Semantics | | Assigned |
| IE/Group Name | Presence | Range | reference | description | Criticality | Criticality |
| DRBs Admitted List | | 1 | | | — | |
| >DRBs Admitted | | 1 . . . | | | — | |
| Item | | <maxnoofDRBs> | | | | |
| >>DRB ID | M | | 9.2.3.33 | | — | |
| >>SN DL SCG UP | M | | UP | S-NG-RAN | — | |
| TNL Information | | | Transport | node GTP-U | | |
| | | | Parameters | tunnel | | |
| | | | 9.2.3.76 | endpoint(s) of | | |
| | | | | the DRB's Xn | | |
| | | | | transport at its | | |
| | | | | Lower Layer | | |
| | | | | SCG resource. | | |
| | | | | For delivery of | | |
| | | | | DL PDUS. | | |
| >>secondary SN | O | | UP | S-NG-RAN | — | |
| DL SCG UP TNL | | | Transport | node GTP-U | | |
| Information | | | Parameters | tunnel | | |
| | | | 9.2.3.76 | endpoint(s) of | | |
| | | | | the DRB's Xn | | |
| | | | | transport at its | | |
| | | | | Lower Layer | | |
| | | | | SCG resource. | | |
| | | | | For delivery of | | |
| | | | | DL PDUs in | | |
| | | | | case of PDCP | | |
| | | | | duplication. | | |
| >>LCID | O | | 9.2.3.70 | LCID for | — | |
| | | | | primary path or | | |
| | | | | LCID for split | | |
| | | | | secondary path | | |
| | | | | for fallback to | | |
| | | | | split bearer if | | |
| | | | | PDCP | | |
| | | | | duplication is | | |
| | | | | applied | | |
| >>Additional | | 0 . . . 1 | | | YES | Ignore |
| PDCP | | | | | | |
| Duplication TNL | | | | | | |
| List | | | | | | |
| >>>Additional | | 1 . . . | | | — | |
| PDCP | | <maxnoofAdditionalPDCPDuplicationTNL> | | | | |
| Duplication TNL | | | | | | |
| Item | | | | | | |
| >>>>Additional | M | | UP | S-NG-RAN | — | |
| PDCP | | | Transport | node GTP-U | | |
| Duplication UP | | | Parameters | tunnel | | |
| TNL Information | | | 9.2.3.76 | endpoint(s) of | | |
| | | | | the DRB's Xn | | |
| | | | | transport at its | | |
| | | | | Lower Layer | | |
| | | | | SCG resource. | | |
| | | | | For delivery of | | |
| | | | | DL PDUs in | | |
| | | | | case of | | |
| | | | | additional | | |
| | | | | PDCP | | |
| | | | | duplication. | | |
| >>QoS Flows | | 0 . . . 1 | | | YES | ignore |
| Mapped To DRB | | | | | | |
| List | | | | | | |
| >>>QoS Flows | | 1 . . . | | | — | |
| Mapped To DRB | | <maxnoofQoSFlows> | | | | |
| Item | | | | | | |
| >>>>QoS Flow | M | | 9.2.3.10 | | — | |
| Identifier | | | | | | |
| >>>>Current | M | | Alternative | | — | |
| Qos | | | QoS | | | |
| Parameters Set | | | Parameters | | | |
| Index | | | Set Index | | | |
| | | | 9.2.3.103 | | | |
| >>XR QoS Flow | O | | 9.2.3.X | | YES | ignore |
| parameters | | | | | | |
| DRBs Not Admitted | O | | DRB List | | YES | ignore |
| To Be Setup or | | | with Cause | | | |
| Modified List | | | 9.2.1.28 | | | |

| Range bound | Explanation |
|---|---|
| maxnoofDRBs | Maximum no. of DRBs allowed towards one UE. Value is 32. |
| maxnoofAdditionalPDCPDuplicationTNL | Maximum no. of additional PDCP Duplication TNL. Value is 2 |

FIG. 7 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3^{rd} Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example illustrated in FIG. 7, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, a content source and analytics node, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

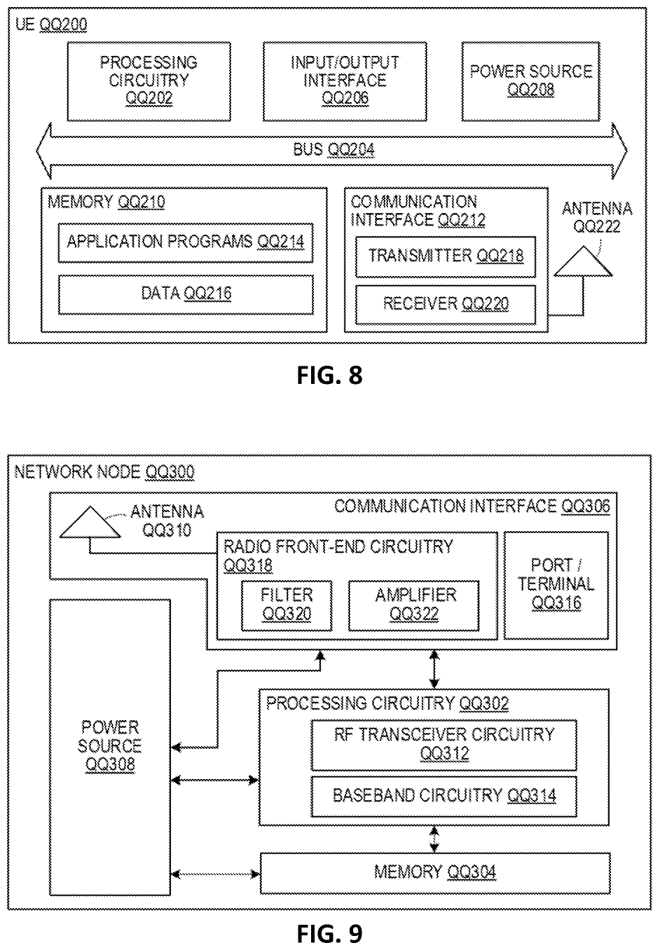

FIG. 8 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs). The processing circuitry QQ202 may be operable to provide, either alone or in conjunction with other UE QQ200 components, such as the memory QQ210, UE QQ200 functionality.

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In some embodiments, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE QQ200 shown in FIG. 8.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 9 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved

Serving Mobile Location Centers (E-SMLCs)), and/or Minimization of Drive Tests (MDTs).

The network node QQ300 includes processing circuitry QQ302, a memory QQ304, a communication interface QQ306, and a power source QQ308, and/or any other component, or any combination thereof. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, network node QQ300 functionality. For example, the processing circuitry QQ302 may be configured to cause the network node to perform the method as described with reference to FIGS. 1 and/or 2.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 9 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

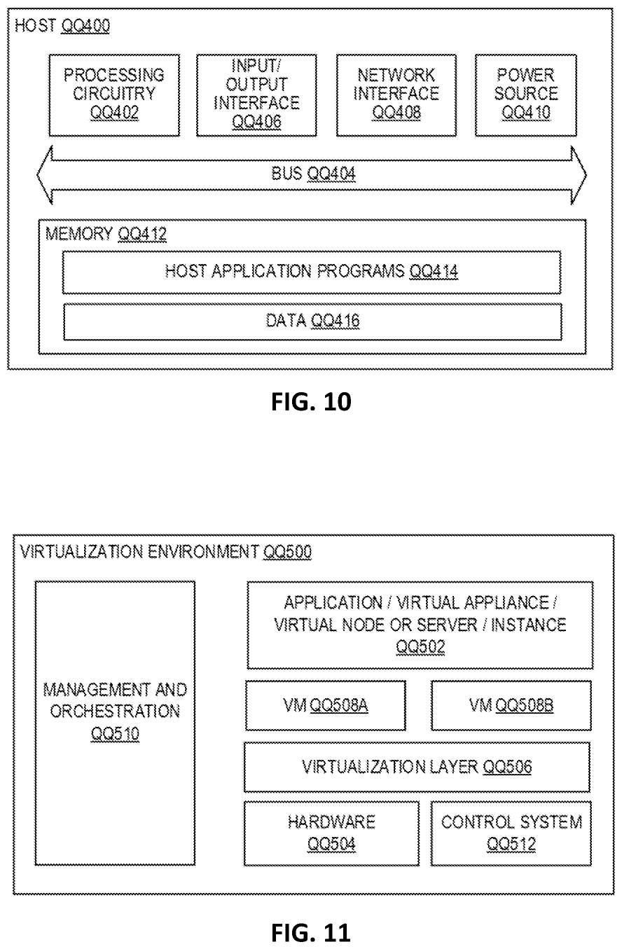

FIG. 10 is a block diagram of a host QQ400, which may be an embodiment of the host QQ116 of FIG. 7, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as Figures QQ2 and QQ3, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 11 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

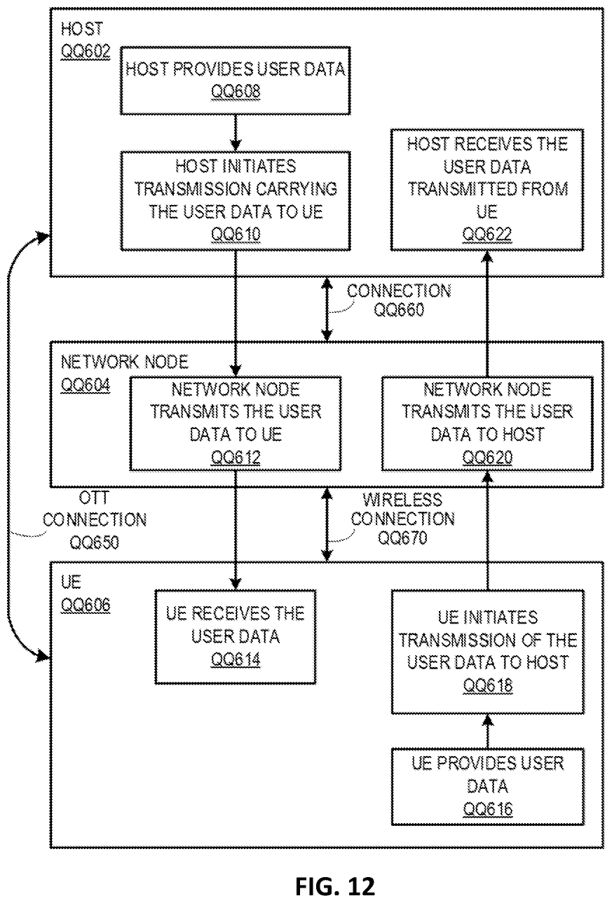

FIG. 12 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 7 and/or UE QQ200 of FIG. 8), network node (such as network node QQ110a of FIG. 7 and/or network node QQ300 of FIG. 9), and host (such as host QQ116 of FIG. 7 and/or host QQ400 of FIG. 10) discussed in the preceding paragraphs will now be described with reference to FIG. 12.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 7) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may improve the throughput, reliability and/or latency of data units transmitted to a UE and thereby provide benefits such as an improved service such as an XR service to a user.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

This disclosure also includes the following example embodiments.

### Group B Embodiments

1. A method performed by a first Radio Access Network (RAN) node for sending a data unit to a second RAN node, the method comprising:
receiving a first data unit for transmission to a User Equipment (UE);
determining that a packet delay budget (PDB) for the first data unit and/or a set of data units including the first data unit will not be satisfied by transmission of the first data unit and/or the set of data units by the first RAN node; and sending the first data unit to a second RAN node for transmission to the UE.
   2. The method of embodiment 1, comprising, before sending the first data unit to the second RAN node for transmission to the UE, sending, to the second RAN node, a request to send the first data unit and/or the set of data units to the second RAN node for transmission to the UE.
   3. The method of embodiment 2, comprising, before sending the first data unit to the second RAN node for transmission to the UE, receiving, from the second RAN node, a response to the request.
   4. The method of embodiment 3, wherein the request includes information identifying at least one of:
a maximum error rate for the first data unit and/or set of data units;
the packet delay budget;
a periodicity of the set of data units;
a size of the data unit and/or the set of data units;
a Transport Network Layer (TNL) address of the first RAN node; and/or
which of duplication, split bearer and/or Quality of Service (QoS) offloading are supported by the first RAN node for sending the first data unit to the second RAN node for transmission to the UE.
   5. The method of embodiment 3 or 4, wherein the response includes information identifying at least one of:
which of duplication, split bearer and/or Quality of Service (QoS) offloading are to be used by the first RAN node for sending the first data unit to the second RAN node for transmission to the UE; and/or
an amount of data that can be transmitted to the UE by the second RAN node.
   6. The method of any of embodiments 1 to 5, wherein determining that the PDB for the first data unit and/or the set of data units will not be satisfied by transmission of the first data unit and/or the set of data units by the first RAN node comprises determining whether the PDB will be met based on radio conditions for the UE and/or traffic conditions at the first RAN node.
   7. The method of any of embodiments 1 to 6, wherein sending the first data unit to the second RAN node for transmission to the UE comprises duplicating the first data unit and/or the set of data units for transmission by the second RAN node to the UE.
   8. The method of embodiment 7, comprising transmitting the first data unit and/or the set of data units to the UE.
   9. The method of embodiment 8, wherein transmitting the first data unit and/or the set of data units to the UE comprises sending the first data unit and/or the set of data units to a lower layer.
   10. The method of embodiment 9, wherein the lower layer comprises a Radio Link Control (RLC) layer.
   11. The method of any of embodiments 1 to 10, wherein sending the first data unit to the second RAN node for transmission to the UE comprises at least one of:
offloading a first Quality of Service (QoS) flow associated with the data unit and/or the set of data units to the second RAN node; and/or
sending the first data unit to the second RAN node according to a split bearer configuration.
   12. The method of any of embodiments 1 to 11, comprising sending one or more additional data units of the set of data units to the second RAN node for transmission to the UE.
   13. The method of embodiment 12, wherein sending one or more additional data units of the set of data units to the second RAN node for transmission to the UE comprises sending a subset of the set of data units to the second RAN node for transmission to the UE.
   14. The method of embodiment 13, comprising transmitting, to the UE, data units in the set of data units other than the subset of the set of data units.
   15. The method of embodiment 14, wherein transmitting, to the UE, data units in the set of data units other than the subset of the set of data units comprises sending the data units in the set of data units other than the subset of the set of data units to a lower layer.
   16. The method of embodiment 15, wherein the lower layer comprises a Radio Link Control (RLC) layer.
   17. The method of embodiment 12, wherein sending one or more additional data units of the set of data units to the second RAN node for transmission to the UE comprises sending all the set of data units to the second RAN node for transmission to the UE.
   18. The method of any of embodiments 1 to 17, wherein the data unit and/or the set of data units is associated with a first Quality of Service (QoS) flow.
   19. The method of embodiment 18, wherein the PDB comprises a Packet Set Delay Budget (PSDB) associated with the first QoS flow.
   20. The method of embodiment 18 or 19, wherein the first QoS flow is associated with an Extended Reality (XR), Augmented Reality (AR), Mixed Reality (MR) and/or Virtual Reality (VR) service.
   21. The method of any of embodiments 18 to 20, wherein the first QoS flow is associated with a second QoS flow, and the method comprises sending, to the second RAN node, data units associated with the second QoS flow and/or sets of data units associated with the second QoS flow.
   22. The method of any of embodiments 1 to 21, wherein receiving the first data unit for transmission to the UE comprises receiving the set of data units for transmission to the UE.
   23. The method of any of embodiments 1 to 22, comprising receiving the first data unit from a higher layer.
   24. The method of embodiment 23, wherein the higher layer comprises a Radio Resource Control (RRC) layer.
   25. The method of any of embodiments 1 to 24, wherein the method is performed by a Packet Data Convergence Protocol (PDCP) layer.
   26. The method of any of embodiments 1 to 25, wherein:
the first data unit comprises a Service Data Unit (SDU), Protocol Data Unit (PDU) or Internet Protocol (IP) packet; and/or
the set of data units comprises a set of SDUs, set of PDUs or set of IP packets.
   27. The method of any of embodiments 1 to 26, wherein the PDB comprises a Packet Set Delay Budget (PSDB) associated with the first data unit and/or the set of data units.
   28. The method of any of embodiments 1 to 27, wherein the first RAN node comprises a first NG-RAN node, and/or the second RAN node comprises a second NG-RAN node.
   29. The method of any of embodiments 1 to 28, wherein:
the first RAN node comprises a Master Node (MN) for the UE, and the second RAN node comprises a Secondary Node (SN) for the UE; or
the second RAN node comprises a MN for the UE and the first RAN node comprises a SN for the UE.
   30. The method of any of embodiments 1 to 29, wherein the UE is configured with Multi-Radio Access Technology Dual Connectivity (MR-DC) with the first RAN node and the second RAN node.
   31. The method of any of the previous embodiments, further comprising:
obtaining user data; and
forwarding the user data to a host or a user equipment.
   32. A method performed by a second Radio Access Network (RAN) node for transmitting a data unit to a user equipment (UE), the method comprising:
receiving, from a first RAN node, a request to send, to the second RAN node for transmission to the UE, a first data unit and/or one or more of a set of data units including the first data unit;
selecting a process for the first RAN node to send at least the first data unit to the second RAN node for transmission to the UE;
sending, to the first RAN node, a response to the request, wherein the request includes information identifying the selected process;
receiving, from the first RAN node, at least the first data unit according to the selected process; and
transmitting at least the first data unit to the UE.
   33. The method of embodiment 32, wherein the request includes information identifying at least one of:
a maximum error rate for the first data unit and/or set of data units;
a packet delay budget (PDB) for the first data unit and/or set of data units;
a periodicity of the set of data units;
a size of the data unit and/or the set of data units;
a Transport Network Layer (TNL) address of the first RAN node; and/or
one or more processes supported by the first RAN node for first RAN node to send at least the first data unit to the second RAN node for transmission to the UE.
   34. The method of embodiment 32 or 33, wherein the one or more processes supported by the first RAN node comprise one or more of duplication, split bearer and/or Quality of Service (QoS) offloading are supported by the first RAN node for sending the first data unit to the second RAN node for transmission to the UE.
   35. The method of embodiment 34, wherein selecting the process for the first RAN node to send at least the first data unit to the second RAN node for transmission to the UE comprises selecting one or more of the one or more processes supported by the first RAN node.
   36. The method of any of embodiments 32 to 35, wherein the response includes information identifying an amount of data that can be transmitted to the UE by the second RAN node.
   37. The method of any of embodiments 32 to 36, wherein transmitting at least the first data unit to the UE comprises sending at least the first data unit to a lower layer.
   38. The method of embodiment 38, wherein the lower layer comprises a Radio Link Control (RLC) layer.
   39. The method of any of embodiments 32 to 38, comprising receiving one or more additional data units of the set of data units from the first RAN node for transmission to the UE, and transmitting the one or more additional data units to the UE.
   40. The method of embodiment 39, wherein the one or more additional data units comprise a subset of the set of data units, or all of the set of data units.
   41. The method of embodiment 12, wherein receiving one or more additional data units of the set of data units to the second RAN node for transmission to the UE comprises sending all the set of data units to the second RAN node for transmission to the UE.
   42. The method of any of embodiments 32 to 41, wherein the data unit and/or the set of data units is associated with a first Quality of Service (QoS) flow.
   43. The method of embodiment 42, wherein the first QoS flow is associated with an Extended Reality (XR), Augmented Reality (AR), Mixed Reality (MR) and/or Virtual Reality (VR) service.
   44. The method of embodiment 42 or 43, wherein the first QoS flow is associated with a second QoS flow, and the method comprises receiving, from the first RAN node, data units associated with the second QoS flow and/or sets of data units associated with the second QoS flow, and transmitting, to the UE, the data units associated with the second QoS flow and/or the sets of data units associated with the second QoS flow.
   45. The method of any of embodiments 32 to 44, wherein the method is performed by a Packet Data Convergence Protocol (PDCP) layer.
   46. The method of any of embodiments 32 to 45, wherein:
the first data unit comprises a Service Data Unit (SDU), Protocol Data Unit (PDU) or Internet Protocol (IP) packet; and/or
the set of data units comprises a set of SDUs, set of PDUs or set of IP packets.
   47. The method of any of embodiments 32 to 46, wherein the first RAN node comprises a first NG-RAN node, and/or the second RAN node comprises a second NG-RAN node.
   48. The method of any of embodiments 32 to 47, wherein:
the first RAN node comprises a Master Node (MN) for the UE, and the second RAN node comprises a Secondary Node (SN) for the UE; or
the second RAN node comprises a MN for the UE and the first RAN node comprises a SN for the UE.
   49. The method of any of embodiments 32 to 48, wherein the UE is configured with Multi-Radio Access Technology Dual Connectivity (MR-DC) with the first RAN node and the second RAN node.
   50. The method of any of embodiments 32 to 49, wherein the process supported by the first RAN node comprise one or more of duplication, split bearer and/or Quality of Service (QoS) offloading are supported by the first RAN node for sending the first data unit to the second RAN node for transmission to the UE.
   51. The method of any of the previous embodiments, further comprising:
obtaining user data; and
forwarding the user data to a host or a user equipment.

### Group C Embodiments

52. A network node comprising:
processing circuitry configured to cause the network node to perform any of the steps of any of the Group B embodiments;
power supply circuitry configured to supply power to the processing circuitry.
   53. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.
   54. The host of the previous embodiment, wherein:
the processing circuitry of the host is configured to execute a host application that provides the user data; and
the UE comprises processing circuitry configured to execute a client application associated with the host application to receive the transmission of user data from the host.
   55. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs any of the operations of any of the Group B embodiments to transmit the user data from the host to the UE.
   56. The method of the previous embodiment, further comprising, at the network node, transmitting the user data provided by the host for the UE.
   57. The method of any of the previous 2 embodiments, wherein the user data is provided at the host by executing a host application that interacts with a client application executing on the UE, the client application being associated with the host application.
   58. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.
   59. The communication system of the previous embodiment, further comprising: the network node; and/or the user equipment.
   60. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.
   61. The host of the previous embodiment, wherein:
the processing circuitry of the host is configured to execute a host application, thereby providing the user data; and
the host application is configured to interact with a client application executing on the UE, the client application being associated with the host application.
   62. The host of the any of the previous 2 embodiments, wherein the initiating receipt of the user data comprises requesting the user data.
   63. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs any of the steps of any of the Group B embodiments to receive the user data from the UE for the host.
   64. The method of the previous embodiment, further comprising at the network node, transmitting the received user data to the host.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1-44. (canceled)

45. A method performed by a first Radio Access Network (RAN) node for sending a data unit to a second RAN node, the method comprising:
receiving a first data unit for transmission to a User Equipment (UE);
determining that a packet delay budget (PDB) for the first data unit and/or a set of data units including the first data unit will not be satisfied by transmission of the first data unit and/or the set of data units by the first RAN node; and
sending the first data unit to a second RAN node for transmission to the UE.

46. The method of claim 45, comprising, before sending the first data unit to the second RAN node for transmission to the UE, sending, to the second RAN node, a request to send the first data unit and/or the set of data units to the second RAN node for transmission to the UE, and receiving, from the second RAN node, a response to the request.

47. The method of claim 46, wherein the request includes information identifying at least one of:
a maximum error rate for the first data unit and/or set of data units;
the packet delay budget;
a periodicity of the set of data units;
a size of the data unit and/or the set of data units;
a Transport Network Layer (TNL) address of the first RAN node; and/or
which of duplication, split bearer and/or Quality of Service (QoS) offloading are supported by the first RAN node for sending the first data unit to the second RAN node for transmission to the UE.

48. The method of claim 46, wherein the response includes information identifying at least one of:
which of duplication, split bearer and/or Quality of Service (QoS) offloading are to be used by the first RAN node for sending the first data unit to the second RAN node for transmission to the UE; and/or
an amount of data that can be transmitted to the UE by the second RAN node.

49. The method of claim 45, wherein determining that the PDB for the first data unit and/or the set of data units will not be satisfied by transmission of the first data unit and/or the set of data units by the first RAN node comprises determining whether the PDB will be met based on radio conditions for the UE and/or traffic conditions at the first RAN node.

50. The method of claim 45, wherein sending the first data unit to the second RAN node for transmission to the UE comprises duplicating the first data unit and/or the set of data units for transmission by the second RAN node to the UE, and the method comprises transmitting the first data unit and/or the set of data units to the UE or sending the first data unit and/or the set of data units to a lower layer.

51. The method of claim 45, wherein sending the first data unit to the second RAN node for transmission to the UE comprises at least one of:
offloading a first Quality of Service (QoS) flow associated with the data unit and/or the set of data units to the second RAN node; and/or
sending the first data unit to the second RAN node according to a split bearer configuration.

52. The method of claim 45, comprising sending one or more additional data units of the set of data units to the second RAN node for transmission to the UE.

53. The method of claim 52, wherein sending one or more additional data units of the set of data units to the second RAN node for transmission to the UE comprises sending a subset of the set of data units to the second RAN node for transmission to the UE, and the method comprises transmitting, to the UE, data units in the set of data units other than the subset of the set of data units or sending the data units in the set of data units other than the subset of the set of data units to a lower layer.

54. The method of claim 52, wherein sending one or more additional data units of the set of data units to the second RAN node for transmission to the UE comprises sending all the set of data units to the second RAN node for transmission to the UE.

55. The method of claim 45, wherein:
the data unit and/or the set of data units is associated with a first Quality of Service (Qos) flow; and
the PDB comprises a Packet Set Delay Budget (PSDB) associated with the first QoS flow and/or the first QoS flow is associated with an Extended Reality (XR), Augmented Reality (AR), Mixed Reality (MR) and/or Virtual Reality (VR) service.

56. The method of claim 55, wherein the first QoS flow is associated with a second QoS flow, and the method comprises sending, to the second RAN node, data units associated with the second QoS flow and/or sets of data units associated with the second QoS flow.

57. A method performed by a second Radio Access Network (RAN) node for transmitting a data unit to a user equipment (UE), the method comprising:
receiving, from a first RAN node, a request to send, to the second RAN node for transmission to the UE, a first data unit and/or one or more of a set of data units including the first data unit;
selecting a process for the first RAN node to send at least the first data unit to the second RAN node for transmission to the UE;
sending, to the first RAN node, a response to the request, wherein the request includes information identifying the selected process;
receiving, from the first RAN node, at least the first data unit according to the selected process; and
transmitting at least the first data unit to the UE.

58. The method of claim 57, wherein the request includes information identifying at least one of:
a maximum error rate for the first data unit and/or set of data units;
a packet delay budget (PDB) for the first data unit and/or set of data units;
a periodicity of the set of data units;
a size of the data unit and/or the set of data units;
a Transport Network Layer (TNL) address of the first RAN node; and/or
one or more processes supported by the first RAN node for first RAN node to send at least the first data unit to the second RAN node for transmission to the UE.

59. The method of claim 57, wherein the one or more processes supported by the first RAN node comprise one or more of duplication, split bearer and/or Quality of Service (QoS) offloading are supported by the first RAN node for sending the first data unit to the second RAN node for transmission to the UE.

60. The method of claim 59, wherein selecting the process for the first RAN node to send at least the first data unit to the second RAN node for transmission to the UE comprises selecting one or more of the one or more processes supported by the first RAN node.

61. The method of claim 57, wherein the response includes information identifying an amount of data that can be transmitted to the UE by the second RAN node.

62. The method of claim 57, wherein transmitting at least the first data unit to the UE comprises sending at least the first data unit to a lower layer.

63. The method of claim 57, comprising receiving one or more additional data units of the set of data units from the first RAN node for transmission to the UE, and transmitting the one or more additional data units to the UE, wherein the one or more additional data units comprise a subset of the set of data units, or all of the set of data units.

64. The method of claim 57, wherein the data unit and/or the set of data units is associated with a first Quality of Service (QoS) flow.

65. A first Radio Access Network (RAN) node for sending a data unit to a second RAN node, the first RAN node comprising a processor and a memory, the memory containing instructions executable by the processor such that the first RAN node is operable to:
receive a first data unit for transmission to a User Equipment (UE);
determine that a packet delay budget (PDB) for the first data unit and/or a set of data units including the first data unit will not be satisfied by transmission of the first data unit and/or the set of data units by the first RAN node; and
send the first data unit to a second RAN node for transmission to the UE.

66. A second Radio Access Network (RAN) node for transmitting a data unit to a User Equipment (UE), the second RAN node comprising a processor and a memory, the memory containing instructions executable by the processor such that the second RAN node is operable to:
receiving, from a first RAN node, a request to send, to the second RAN node for transmission to the UE, a first data unit and/or one or more of a set of data units including the first data unit;
select a process for the first RAN node to send at least the first data unit to the second RAN node for transmission to the UE;
send, to the first RAN node, a response to the request, wherein the request includes information identifying the selected process;
receive, from the first RAN node, at least the first data unit according to the selected process; and
transmit at least the first data unit to the UE.
